(19) United States
(12) Patent Application Publication
(10) Pub. No.: US 2010/0058459 A1
(43) Pub. Date: Mar. 4, 2010

(54) NETWORK INTERFACE CARD WITH PACKET FILTERING FUNCTION AND FILTERING METHOD THEREOF

(75) Inventors: Yan Li, Tianjin (CH); Tom Chen, Taipei (TW)

Correspondence Address: STEVENS & SHOWALTER LLP, 7019 CORPORATE WAY, DAYTON, OH, 45459-4238, US

(73) Assignee: INVENTEC CORPORATION, Taipei (TW)

(21) Appl. No.: 12/241,924

(22) Filed: Sep. 30, 2008

(30) Foreign Application Priority Data
Aug. 27, 2008 (TW) 097132802

(51) Int. Cl. G06F 13/14; G06F 15/16

(52) U.S. Cl. 726/13; 710/305

(57) ABSTRACT

A network interface card with a packet filtering function and a filtering method thereof are applicable to realize packet filtering through both software and hardware manners. The network interface card includes a connection port, a first filtering module, a second filtering module, and a storage unit. The connection port is used to receive a packet data from Internet. The first filtering module is connected to the connection port, and is used to detect the packet data according to a content address memory (CAM) table. The detecting process is executed by a firmware of the network interface card. The second filtering module is connected to the first filtering module, and executes a packet content detecting procedure for detecting a content of the packet data, thereby detecting the packet data by using software/firmware respectively, and thus a working efficiency of the network interface card is enhanced.

### CROSS-REFERENCE TO RELATED APPLICATIONS

This non-provisional application claims priority under 35 U.S.C. § 119(a) on Patent Application No(s). 097132802 filed in Taiwan, R.O.C. on Aug. 27, 2008 the entire contents of which are hereby incorporated by reference.

### BACKGROUND OF THE INVENTION

1. Field of the Invention

The present invention relates to network equipment, and more particularly to a network interface card and a filtering method thereof.

2. Related Art

Recently, more and more complicated viruses, worms, attack of denial of service, and malicious intrusion of hacker have caused a loss of a billion dollars to many commercial units. In view of attack behavior of the applications, due to the response characteristics of the conventional solutions, and the powerlessness on the continuously changed attacks, the conventional security manners, for example, a firewall and a network intrusion detection system are not sufficient for preventing the behaviors. The current demand lies in instantly intercepting the attack and the intrusion, so as to protect the large quantities of company assets.

In order to prevent the above attacks, an intrusion protection system (IPS) has been proposed. The IPS detects the intrusion based on the analysis on network packet flow states. The IPS system is active on-line equipment, which can drop the attacking data packet or disconnect before the data packet reaches the host.

There are mainly two particular manners for realizing the IPS. One is to realize through hardware, and the other is to realize through software. The realizing manner through hardware is relatively common in mainstream commercial products, whereas the realizing manner through software is relatively common in free open-source systems. The two manners have respective advantages and disadvantages. The advantage of the realizing manner through hardware lies in the performance, in which all the logic processing is finished by dedicated hardware, so the performance thereof is usually excellent. Since the dedicated hardware architecture is adopted, the expansion and the flexibility of the hardware system are insufficient, and the expansion for rule definition is poor. In other words, due to the complexity, the rule definition of the hardware system is difficult to be expanded, so that the upgrading maintenance has a relatively high cost. The advantages and disadvantages of the realizing manner through software are just opposite to that of the realizing manner through hardware.

### SUMMARY OF THE INVENTION

In view of the above problems, the present invention is directed to a network interface card with a packet filtering function, which is applicable to realize packet filtering through software and hardware manners simultaneously.

As embodied and broadly described herein, a network interface card with a packet filtering function is provided in the present invention, which includes a connection port, a first filtering module, a second filtering module, a storage unit, and an computing unit. The connection port is used to receive a packet data from Internet. The first filtering module is electrically connected to the connection port, and is used to detect the packet data according to a content address memory (CAM) table. The detecting process is executed through hardware of the network interface card. The second filtering module is electrically connected to the first filtering module, and executes a packet content detecting procedure for detecting a content of the packet data. The second filtering module detects the packet data by using software/firmware. The storage unit is electrically connected to the connection port, and is used to store the CAM table and the second filtering module. The computing unit is electrically connected to the connection port and the storage unit, and is used to execute the packet content detecting procedure.

From another aspect of the present invention, the present invention is further directed to a packet filtering method, which is applicable to filter a packet received by a network interface card.

A packet filtering method is provided in the present invention, which includes: establishing an orthogonal list, for determining whether it is necessary to process a packet data by a first filtering module or not; receiving a plurality of packet data; filtering by the first filtering module, in which the received packet data is detected according to a CAM table; filtering by a second filtering module, in which a packet content detecting procedure is executed on the packet data passing through the first filtering module; executing a packet processing procedure and executing a corresponding packet filtering policy, including dropping the packet data that fails to pass though the filtering modules, accepting or forwarding the packet data passing through the filtering modules.

In the present invention, packet filtering is realized on the network interface card through a hardware manner and a software manner at the same time. After receiving a packet data, the network interface card parses the packet data according to a matching condition, so as to classify the packet data into a hardware filtering process or a software filtering process. In the present invention, the network interface card may add new conditions or adjust the existing defects by setting software filtering conditions, and also take the executing speed of hardware detection into consideration.

### BRIEF DESCRIPTION OF THE DRAWINGS

The present invention will become more fully understood from the detailed description given herein below for illustration only, and thus is not limitative of the present invention, and wherein:

FIG. 1 is a schematic view of system architecture of the present invention;

FIG. 2 is a schematic view of a CAM table and items therein; and

FIG. 3 is a schematic view of an operating flow of the present invention.

### DETAILED DESCRIPTION OF THE INVENTION

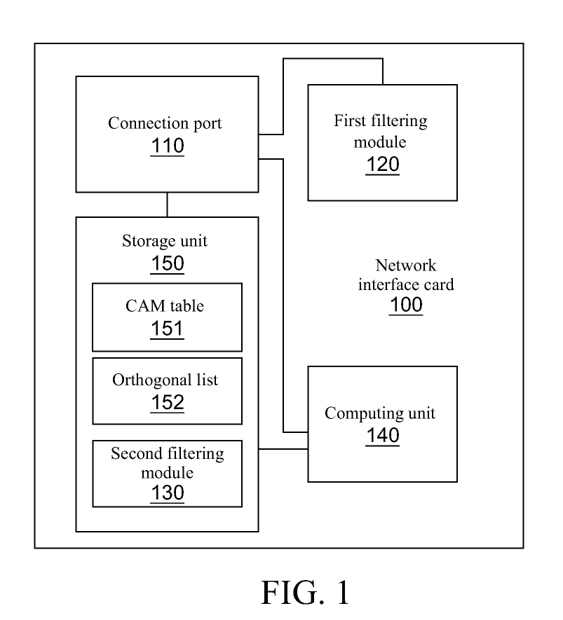

FIG. 1 is a schematic view of system architecture of the present invention. Referring to FIG. 1, a network interface card 100 of the present invention may be disposed in a computer device, and may also be realized in other network equipments. The network interface card 100 of the present invention is a NetXen network interface card. The network interface card 100 includes a connection port 110, a first filtering module 120, a second filtering module 130, a computing unit 140, and a storage unit 150. The connection port 110 is used to receive a packet data from Internet. In the present invention, the connection port 110 is not limited to one connection port, but may be a plurality of connection ports. If a plurality of connection ports 110 exists, one of them may be set as a communication port for receiving a data packet from an external network, and the remaining connection ports are set as communication ports for transmitting a data packet to an internal network, so as to transmit the processed data packet to other computer devices.

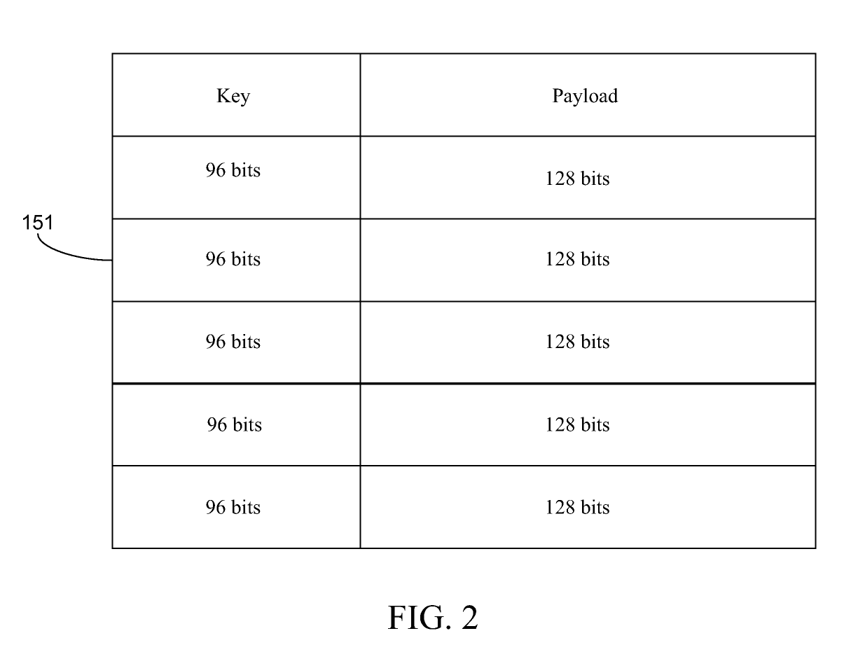

The storage unit 150 is electrically connected to the connection port 110, and is used to store a CAM table 151 and an orthogonal list 152. The CAM table 151 includes a plurality of recording items, and each of the recording items includes a key with a length of 96 bits and a payload with a length of 128 bits. FIG. 2 is a schematic view of a CAM table and items therein.

The orthogonal list 152 is used to determine whether it is necessary to process a packet data by the first filtering module 120 or not. The orthogonal list may be considered as a list obtained by combining an adjacent list and an inverse adjacent list of a directed graph. In the orthogonal list, each edge of the directed graph corresponds to one node, and each vertex also corresponds to one node. The structure of the nodes is shown as follows.

TABLE 1
schematic view of an edge node structure

| | | | | |
|---|---|---|---|---|
| tailvex | headvex | hlink | tlink | info |

TABLE 2
schematic view of a vertex node structure

| | | |
|---|---|---|
| data | firstin | firstout |

The edge node includes five fields, in which a tail field (tailvex) and a head field (headvex) respectively indicate positions of the two vertexes, edge tail and edge head, in the graph; a link field (hlink) indicates the next edge with the same edge head as the current edge; another link field (tlink) indicates the next edge with the same edge tail as the current edge; and an info field indicates relevant information of the edge. The edges with the same head are on the same list, and the edges with the same tail are also on the same list. Their head node is the vertex node, which is formed by three fields. A data field stores relevant information of the vertex, for example, name of the vertex, and firstin and firstout are two key fields, respectively indicating the first edge node with the vertex as the head or the tail.

In order to describe the detecting manner of the present invention conveniently, a data structure is set as an example herein for demonstration.

```
struct itc_ips_rule
{
  struct list_head mainChain;
  struct list_head accelerateChain;
  void *rule;
  struct protocolMask ruleMask;
  int ruleProperty;
  int validity;
  struct itc_ips_rule_count count;
  unsigned int target;
};
```

The meaning of each field is described as follows. mainChain: is used to maintain an index of the orthogonal list 152 when the rule node is in a transverse main rule chain. accelerateChain: is used to maintain an index of the orthogonal list 152 when the rule node is in a longitudinal accelerating rule chain. Rule: when the rule defines that the filter matching is executed through software, it indicates the practical rule data; and when the rule defines that the filter matching is executed through hardware, this field has no meaning. ruleMask: this field specifies the protocol mask of the rule. ruleProperty: this field specifies the attribute of the rule, that is, hardware filtering or software filtering. Validity: this field is only valid for the hardware acceleration rule and definitely indicates whether the rule is hit or not in the filtering matching through hardware, and the address of the field will be written into the payload of the recording item in the CAM table 151 of the corresponding hardware rule, which realizes the correlation between software and hardware. Count: this field is used to calculate the rule hitting situations in statistics. Target: this field indicates relevant operations that should be executed after the rule is hit.

The first filtering module 120 is electrically connected to the connection port 110, and is used to detect a packet data according to the CAM table 151. The detecting process is executed by the hardware of the network interface card 100. It should be noted that, the second filtering module 130 of the present invention is executed in a software manner. The second filtering module 130 is stored in the storage unit 150. The second filtering module 130 executes a packet content detecting procedure for detecting a content of the packet data. The second filtering module 130 may detect the packet data in a software manner, and may also add/modify filtering conditions in the second filtering module 130 in a software manner. The computing unit 140 is electrically connected to the connection port 110 and the storage unit 150, and is used to execute the packet content detecting procedure.

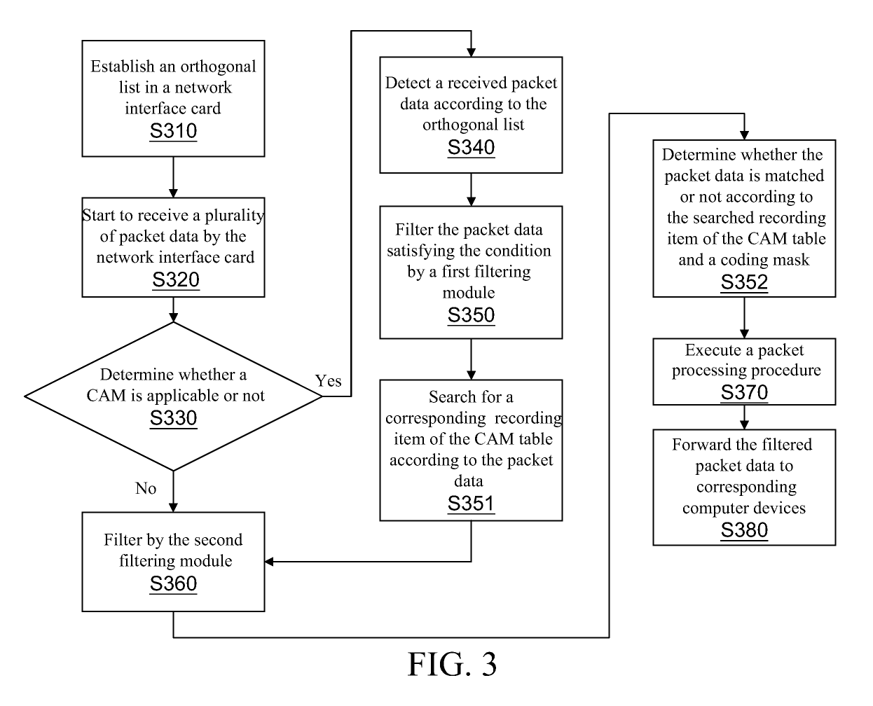

FIG. 3 is a schematic view of an operating flow of the present invention. Referring to FIG. 3, the operating flow of the present invention includes the following steps. An orthogonal list is established in the network interface card (Step S310), such that the received packet data is detected by a corresponding filtering module.

Then, the network interface card starts to receive a plurality of packet data (Step S320). It is determined whether a CAM is applicable or not, so as to decide whether to execute the hardware filtering or not (Step S330). The filtering sequence of the first filtering module and the second filtering module is decided by an index of the orthogonal list. In other words, the nodes in the orthogonal list are the unified index of all the rules (the first filtering module and the second filtering module). The received packet data is detected according to the orthogonal list (Step S340).

The first filtering module 120 executes hardware filtering on the received packet. However, the hardware filtering may not hit. When the first filtering module 120 is hit during filtering, the first filtering module 120 returns a corresponding rule (that is, an address of the correlation validity in the orthogonal list 152) from recording items in the CAM table 151. When the first filtering module 120 returns the address of the correlation validity, it proves that the hardware filtering through CAM table hits. Next, the bits of the address content of the correlation validity are reset (provided for being examined during the subsequent software filtering to check whether the hardware filtering hits or not). If no address of the correlation validity is returned, it is proved that the hardware filtering through CAM table 151 does not hit, and the flow directly enters the subsequence processing.

Then, the packet data satisfying the condition is turned to be filtered by the first filtering module (Step S350). Step S350 further includes: searching for a corresponding recording item of the CAM table according to the packet data (Step S351); and then, determining whether the packet data is matched or not according to the searched recording item of the CAM table and a coding mask (Step S352).

After being processed through Step S340, Step S350, Step S351, and Step S352, the packet data is turned to be filtered by the second filtering module (Step S360), in which the packet content detecting procedure is executed on the packet data. When executing the software filtering, the second filtering module 130 retrieves rules one by one according to the index of the list. When there is a packet satisfying the software rule, the second filtering module 130 executes a corresponding program to detect and filter the packet. On the contrary, when there is a packet satisfying the hardware rule, the second filtering module 130 detects whether the validity of the packet is set or not, and if yes, it indicates that the packet is hit during the hardware filtering, so that the second filtering module 130 executes corresponding forwarding, accepting, or dropping operation according to the rule.

Then, a packet processing procedure is executed (Step S370), and a corresponding packet filtering policy is executed, including dropping the packet data that fails to pass though the filtering modules, accepting or forwarding the packet data passing through the filtering modules. Finally, the filtered packet data is forwarded to corresponding computer devices (Step S380).

In the present invention, packet filtering is realized on the network interface card through a hardware manner and a software manner at the same time on the network interface card 100. After receiving a packet data, the network interface card 100 parses the packet data according to a matching condition, so as to classify the packet data into a hardware filtering process or a software filtering process. In the present invention, the network interface card 100 may add new conditions or adjust the existing defects by setting software filtering conditions, and also take the executing speed of hardware detection into consideration.

What is claimed is:

1. A network interface card with a packet filtering function, applicable to realize packet filtering through software and hardware manners simultaneously, comprising:
a connection port, for receiving a packet data from Internet;
a first filtering module, electrically connected to the connection port, for detecting the packet data according to a content address memory (CAM) table;
a second filtering module, connected to the first filtering module and the connection port, for executing a packet content detecting procedure, so as to detect a content of the packet data and execute a corresponding packet filtering policy; and
a storage unit, electrically connected to the connection port, for storing the CAM table and the second filtering module.

2. The network interface card with a packet filtering function according to claim 1, wherein the network interface card is a NetXen network interface card.

3. The network interface card with a packet filtering function according to claim 1, further comprising: a computing unit, electrically connected to the connection port and the storage unit, for executing the packet content detecting procedure.

4. The network interface card with a packet filtering function according to claim 1, wherein the CAM table comprises a plurality of recording items and each of the recording items comprises a key with a length of 96 bits and a payload with a length of 128 bits.

5. The network interface card with a packet filtering function according to claim 1, wherein the storage unit further comprises an orthogonal list, for determining whether it is necessary to process the packet data by the first filtering module or not.

6. A packet filtering method, applicable to filter a packet received by a network interface card, comprising:
receiving a plurality of packet data;
determining whether a content address memory (CAM) is applicable or not, so as to decide whether to execute hardware filtering or not;
filtering by a first filtering module, wherein the received packet data is detected according to a CAM table;
filtering by a second filtering module, wherein a packet content detecting procedure is executed on the packet data passing through the first filtering module; and
executing a packet processing procedure, and executing a corresponding packet filtering policy.

7. The packet filtering method according to claim 6, wherein before filtering by the first filtering module, the method further comprises: establishing an orthogonal list for determining whether it is necessary to process the packet data by the first filtering module or not.

8. The packet filtering method according to claim 6, wherein when filtering by the first filtering module, the method further comprises:
searching for a recording item in the CAM table corresponding to the packet data; and
determining whether the packet data is matched or not according to the searched recording item in the CAM table and a coding mask.

9. The packet filtering method according to claim 6, wherein when executing the packet processing procedure, the method further comprises: deciding to drop the packet data that fails to pass though the filtering modules, accept or forward the packet data passing through the filtering modules according to a packet filtering result.
